(19) United States
(12) Patent Application Publication
(10) Pub. No.: US 2023/0209007 A1
(43) Pub. Date: Jun. 29, 2023

(54) METHOD, DEVICE AND NON-TRANSITORY COMPUTER-READABLE MEDIUM FOR PERFORMING IMAGE PROCESSING

(71) Applicant: IPEVO CORP., Taipei (TW)

(72) Inventors: Royce Yu-Chun Hong, Taipei (TW); Shih-Chi Huang, Taipei (TW); Ke-Hwa Weng, Taipei (TW); Chih-Kang Tuan, Taipei (TW)

(21) Appl. No.: 18/146,106

(22) Filed: Dec. 23, 2022

Related U.S. Application Data
(60) Provisional application No. 63/365,501, filed on May 31, 2022.
(60) Provisional application No. 63/293,470, filed on Dec. 23, 2021.

(51) Int. Cl. H04N 5/262; G06T 7/70

(52) U.S. Cl. CPC H04N 5/2628; G06T 7/70; G06T 2200/24; G06T 2207/30201

(57) ABSTRACT

A method for performing image processing is provided. In the method, an input image is obtained. A detection of at least one human is performed based on the input image. In a case that only one human is detected based on the input image, a determination of an output region within the input image is performed based on a face orientation of the only one human detected, and an output image is generated based on the output region within the input image. In addition, an image processing device and a non-transitory computer-readable medium using the method are also provided.

### CROSS-REFERENCE TO RELATED APPLICATION(S)

The present application claims the benefit of and priority to U.S. Provisional Patent Application Ser. No. 63/293,470, filed on Dec. 23, 2021, entitled “METHOD FOR SELECTING AN OUTPUT REGION IN A CAPTURED IMAGE,” and to U.S. Provisional Patent Application Ser. No. 63/365,501, filed on May 31, 2022, entitled “AI-POWERED VIDEO CONFERENCING SYSTEM.” The contents of all of the above-mentioned applications are hereby fully incorporated herein by reference for all purposes.

### FIELD

The present disclosure generally relates to an image processing technology, and more specifically, to methods, devices, and non-transitory computer-readable media for selecting an output region in a captured image.

### BACKGROUND

As the trend of working from home increases, the demand for video streaming devices also increases. People try to use technology to avoid face-to-face meetings, saving unnecessary commutes and office costs. However, face-to-face meetings have many advantages that current technology cannot replace. For example, a lively presenter in a meeting may use every corner in a large space, and the participants in the meeting will naturally shift their gaze to the presenter's location or the place where the presenter is paying attention. The use of a camera with a limited field of view and a flat display panel of limited size does not allow such vivid presentation unless the presenter controls the orientation and focus of the camera, typically while suspending the presentation.

### SUMMARY

The present disclosure is directed to methods, devices, and non-transitory computer-readable media for image processing, which transforms an input image into an output image focusing on a region of interest. As such, more intelligent video streaming can be provided, and a more efficient and professional remote conference can be achieved.

According to a first aspect of the present disclosure, a method for performing image processing is provided. The method includes obtaining a first input image; detecting human based on the first input image; and in a case that only one human is detected based on the first input image: determining a first output region within the first input image based on a face orientation of the only one human detected; and generating a first output image based on the first output region within the first input image.

In an implementation of the first aspect, the method further includes, in a case that a plurality of humans is detected based on the first input image: determining the first output region within the first input image based on a plurality of positions of the plurality of humans detected; and generating the first output image based on the first output region within the first input image.

In another implementation of the first aspect, the method further includes determining first size information of the first output image. The first output region is further determined according to the first size information.

In another implementation of the first aspect, the face orientation indicates that the only one human detected is facing towards a direction, and determining the first output region within the first input image based on the face orientation of the only one human detected includes determining a candidate region based on a position of the only one human detected according to the first size information; moving the candidate region along the direction without exceeding a border of the first input image; and determining the first output region based on the candidate region.

In another implementation of the first aspect, the method further includes obtaining at least one second input image; detecting at least one human based on the first input image; and in a case that only one human is detected based on the first input image: determining a first output region within the first input image based on a face orientation of the only one human detected; and generating a first output image based on the first output region within the first input image.

In another implementation of the first aspect, in a case that the selected one of the plurality of display modes is a face tracking mode, generating the virtual camera image based on the first output image and the at least one second output image according to the selected one of the plurality of display modes includes generating a face setting image including a plurality of faces in the first output image and the at least one second output image; receiving a selection signal designating one of the plurality of faces; determining, from the first output image and the at least one second output image, at least one candidate image that includes the designated one of the plurality of faces; and generating the virtual camera image based on the at least one candidate image.

In another implementation of the first aspect, determining, from the first output image and the at least one second output image, the at least one candidate image that includes the designated one of the plurality of faces includes periodically detecting the designated one of the plurality of faces in the first output image and the at least one second output image; and determining the at least one candidate image from one or more of the first output image and the at least one second output image in which the designated one of the plurality of faces is detected.

According to a second aspect of the present disclosure, an image processing device is provided. The image processing device includes one or more processors and one or more non-transitory computer-readable media coupled to the one or more processors and storing instructions. The instructions, when executed by the one or more processors, cause the image processing device to obtain a first input image; detect at least one human based on the first input image; and in a case that only one human is detected based on the first input image: determine a first output region within the first input image based on a face orientation of the only one human detected; and generate a first output image based on the first output region within the first input image.

According to a third aspect of the present disclosure, a non-transitory computer-readable medium storing instructions is provided. The instructions, when executed by the one or more processors of an electronic device, cause the electronic device to obtain a first input image; detect at least one human based on the first input image; and in a case that only one human is detected based on the first input image: determine a first output region within the first input image based on a face orientation of the only one human detected; and generate a first output image based on the first output region within the first input image.

### BRIEF DESCRIPTION OF THE DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 is a block diagram illustrating an image processing device according to an example implementation of the present disclosure.

FIG. 2 is a diagram illustrating a user interface (UI) displaying a virtual camera image that has one image source according to an example implementation of the present disclosure.

FIG. 3 is a diagram illustrating the UI displaying the virtual camera image that has multiple image sources according to an example implementation of the present disclosure.

FIG. 4 is a diagram illustrating the UI displaying the virtual camera image that has multiple image sources according to another example implementation of the present disclosure.

FIG. 5 is a flowchart illustrating a display method of an auto switch mode according to an example implementation of the present disclosure.

FIG. 6 is a diagram illustrating a face setting image according to an example implementation of the present application.

FIG. 7 is a flowchart illustrating a display method of a face tracking mode according to an example implementation of the present disclosure.

FIGS. 8A to 8D are diagrams illustrating output images of the portrait function according to an example implementation of the present disclosure.

FIG. 9 is flowchart illustrating an image processing method of the portrait function according to an example implementation of the present disclosure.

FIG. 10A is a diagram illustrating the input image according to an example implementation of the present disclosure.

FIG. 10B is a diagram illustrating the input image according to another example implementation of the present disclosure.

FIG. 11A is a diagram illustrating a union rectangle calculated based on the input image shown in FIG. 10A according to an example implementation of the present disclosure.

FIG. 11B is a diagram illustrating a union rectangle calculated based on the input image shown in FIG. 10B according to an example implementation of the present disclosure.

FIG. 12A is a diagram illustrating a candidate rectangle calculated based on the union rectangle shown in FIG. 11A according to an example implementation of the present disclosure.

FIG. 12B is a diagram illustrating a candidate rectangle calculated based on the union rectangle shown in FIG. 11B according to an example implementation of the present disclosure.

FIG. 13 is a diagram illustrating a movement of the candidate rectangle shown in FIG. 12B according to an example implementation of the present disclosure.

FIG. 14 is a diagram illustrating an adjustment of the candidate rectangle shown in FIG. 13 according to an example implementation of the present disclosure.

FIG. 15 is a diagram illustrating output images of the conference function according to an example implementation of the present disclosure.

FIG. 16 is flowchart illustrating an image processing method of the conferencing function according to an example implementation of the present disclosure.

FIG. 17 is flowchart illustrating an image processing method of the document function according to an example implementation of the present disclosure.

### DESCRIPTION

Before the disclosure is described in greater detail, it should be noted that, where considered appropriate, reference numerals have been repeated among the figures to indicate corresponding or analogous elements, which may optionally have similar characteristics.

To aid in describing the disclosure, directional terms may be used in the specification and claims to describe portions of the present disclosure (e.g., front, rear, left, right, top, bottom, etc.). These directional definitions are intended to merely assist in describing and claiming the disclosure and are not intended to limit the disclosure in any way.

The following contains specific information pertaining to example implementations in the present disclosure. The drawings and their accompanying detailed disclosure are directed to merely example implementations of the present disclosure. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features are identified (although, in some examples, not illustrated) by numerals in the example figures. However, the features in different implementations may differ in other respects, and thus shall not be narrowly confined to what is illustrated in the figures.

References to “one implementation,” “an implementation,” “example implementation,” “various implementations,” “some implementations,” “implementations of the present disclosure,” etc., may indicate that the implementation(s) of the present disclosure may include a particular feature, structure, or characteristic, but not every possible implementation of the present disclosure necessarily includes the particular feature, structure, or characteristic. Further, repeated use of the phrase “in one implementation,” “in an example implementation,” or “an implementation,” do not necessarily refer to the same implementation, although they may. Moreover, any use of phrases like “implementations” in connection with “the present disclosure” are never meant to characterize that all implementations of the present disclosure must include the particular feature, structure, or characteristic, and should instead be understood to mean “at least some implementations of the present disclosure” includes the stated particular feature, structure, or characteristic. The term “coupled” is defined as connected, whether directly or indirectly through intervening components, and is not necessarily limited to physical connections. The term “comprising,” when utilized, means “including but not necessarily limited to”; it specifically indicates open-ended inclusion or membership in the disclosed combination, group, series, and the equivalent.

Additionally, for a non-limiting explanation, specific details, such as functional entities, techniques, protocols, standards, and the like, are set forth for providing an understanding of the disclosed technology. In other examples, detailed disclosure of well-known methods, technologies, systems, architectures, and the like are omitted so as not to obscure the present disclosure with unnecessary details.

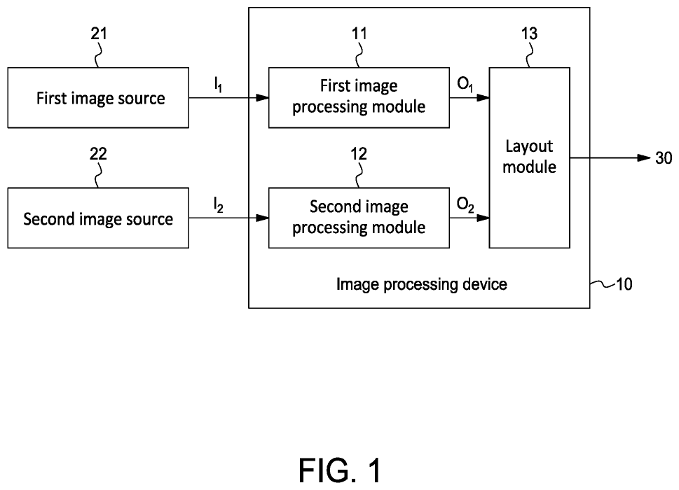

FIG. 1 is a block diagram illustrating an image processing device 10 according to an example implementation of the present disclosure.

Referring to FIG. 1, the image processing device 10 may receive one or more input images I1, I2 from one or more image sources 21, 22 and generate a virtual camera image 30 by performing image processing based on the one or more input images I1, I2. The image sources 21, 22 may be, for example, cameras (e.g., wide-angle camera, omnidirectional camera, etc.), but which is not limited herein.

In some implementations, the image processing device 10 may be embedded in an electronic device (e.g., a personal computer (PC), a laptop, a smart phone, a tablet PC, etc.).

In some implementations, the image processing device 10 may be disposed in an image presenter, a digital visualizer, or a document camera device that may connected to an external electronic device (e.g., a desktop PC, a laptop PC, a smart phone, a tablet PC, etc.).

In some implementations, the image sources 21, 22 may be cameras disposed on the same image presenter, a digital visualizer, or a document camera device.

In some implementations, the image processing device 10 may receive the first input image I1 and the second input image I2 from the first image source 21 and the second image source 22, respectively, as shown in FIG. 1. However, the number of the input images and their sources are not limited in the present disclosure.

In some implementations, two input images may come from the same image source.

In some implementations, the image processing device 10 may only receive one input image from one image source and generate the virtual camera image 30 by performing image processing based on the only one input image.

In some implementations, the image processing device 10 may receive more than two input images (e.g., n input images) from one or more image sources (e.g., 1, 2, . . . , or n image sources) and generate the virtual camera image 30 by performing image processing based on the more than two input images.

As illustrated in FIG. 1, the image processing device 10 may include one or more image processing modules 11, 12 corresponding to the one or more input images I1, I2, and a layout module 13. The one or more image processing modules 11, 12 may be configured to perform image processing on the one or more input images I1, I2 to generate one or more output images O1, O2, respectively, and the layout module 13 may be configured to determine an output layout and generate a virtual camera image 30 accordingly by using the one or more output images O1, O2.

The image processing performed by the image processing modules 11, 12 may include one or more of the traditional image processing methods such as keystone adjustment, scaling, rotation, one or more of the image processing methods in one or more implementations described below, or a combination thereof.

The determination of the output layout performed by the layout module 13 includes which output image(s) is selected for the virtual camera image 30 and an arrangement of the selected output image(s) in the virtual camera image 30.

In some implementations, the image processing device 10 may support multiple display modes, such as a default mode, a picture-in-picture (PiP) mode, a split screen mode, an auto switch mode, and/or a face tracking mode. The image processing device 10 may receive a mode selection signal for selecting one of the display modes, and the image processing modules 11, 12, and the layout module 13 may operate according to the selected display mode.

In some implementations, the first image processing module 11 may receive the first input image I1 from the first image source 21, perform image processing on the first input image I1, and generate a first output image O1; the second image processing module 12 may receive the second input image I2 from the second image source 22, perform image processing on the second input image I2, and generate a second output image O2; and the layout module 13 may receive the first output image O1 and the second output image O2, and generate the virtual camera image 30 based on the first output image O1 and the second output image O2 (e.g., according to the selected display mode).

It should be noted that the present disclosure does not limit the use of the virtual camera image 30. For example, the virtual camera image 30 may serve as a final output of the local end and directly transmitted to a remote end. For example, the virtual camera image 30 may be served as an input of an application (e.g., an image processing application such as Photoshop® by Adobe® Inc., a video conferencing application such as Skype® by Microsoft® Corporation or Zoom™ by Zoom Video Communications, Inc., etc.).

In some implementations, the image processing device 10 may include an input/output (I/O) interface or couple to an electronic device that includes an I/O interface. Through the I/O interface, a user interface may be displayed, signals may be received, and, as such, an interaction between the image processing device 10 and a user may be achieved.

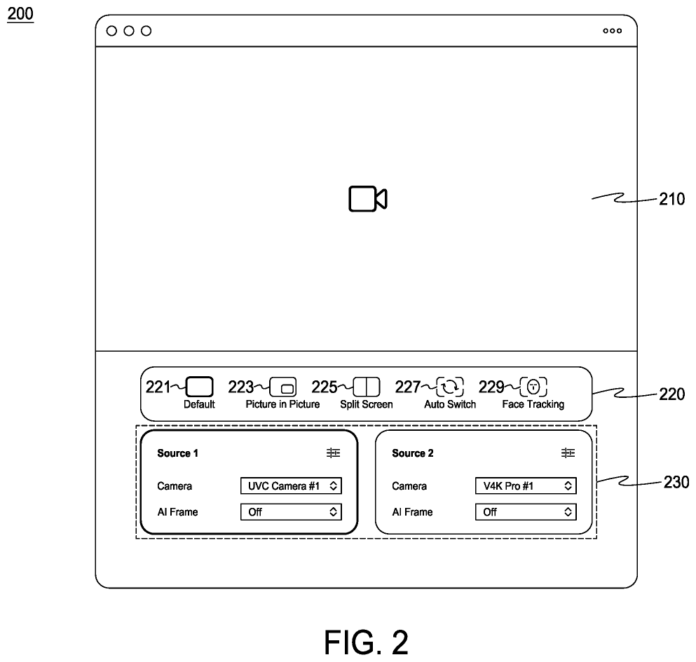

FIG. 2 is a diagram illustrating a user interface (UI) 200 displaying a virtual camera image that has one image source according to an example implementation of the present disclosure.

Referring to FIG. 2, the user interface 200 may include a display area 210, a mode selection area 220, and an image source configuration area 230.

The display area 210 may be configured to display at least one image. According to different settings, the at least one image displayed in the display area 210 may include at least one of the one or more input images I1, I2, at least one of the one or more output images O1, O2, the virtual camera image 30, at least one functional image (will be described), or a combination thereof.

The mode selection area 220 may be configured to provide a mode selection list including multiple display modes.

In some implementations, the mode selection list may include a default mode 221, a picture-in-picture (PIP) mode 223, a split screen mode 225, an auto switch mode 227, and a face tracking mode 229.

The image source configuration area 230 may be configured to provide an image source selection list for setting each image source. In addition, the image source configuration area 230 may be configured to provide a function selection list for selecting an image processing method to frame each input image I1, I2 according to the selected function.

In some implementations, the function selection list may include a portrait function, a conferencing function, and a document function. Each of the portrait function, the conferencing function, and the document function will be described below. The image processing module 11, 12 may perform an image processing method on the first input image I1 and the second input image I2 according to the selected function, respectively, to generate the first output image O1 and the second output image O2. In a case that no function is selected for a specific input image, the specific input image may not be framed for generating the corresponding output image.

Default Mode

In further reference to FIG. 2, the default mode 221 may be selected (e.g., by default or by the user). In the default mode 221, one of the one or more output images O1, O2 may be selected (e.g., by default or by the user) for generating the virtual camera image 30 by the layout module 13. The layout module 13 may receive all of the one or more output images O1, O2 and take the selected output image as the virtual camera image 30. As a result, the display area 210 may display a virtual camera image 30 that has only one image source.

In some implementations, the one of the one or more output image O1, O2 may be selected by selecting one of the image source(s) from the image source configuration area 230.

For example, in a case that the first image source/first camera 21 in the image source configuration area 230 is clicked or selected, the layout module 13 may take the first output image O1 as the virtual camera image 30. In this case, the display area 210 may display a virtual camera image 30 which is the same as the first output image O1 associated with the first image source 21.

In some implementations, all of the one or more output images O1, O2 may be displayed in the display area 210, a selection signal may be received, then the one of the one or more output images O1, O2 may be selected based on the selection signal.

For example, in a case that one of the one or more output images O1, O2 displayed in the display area 210 is clicked or selected, the layout module 13 may take the clicked or selected output image as the virtual camera image 30.

Picture-in-Picture Mode

In some implementations, in a case that only one image source exists, the PIP mode 223 may be disabled and prohibited from being selected.

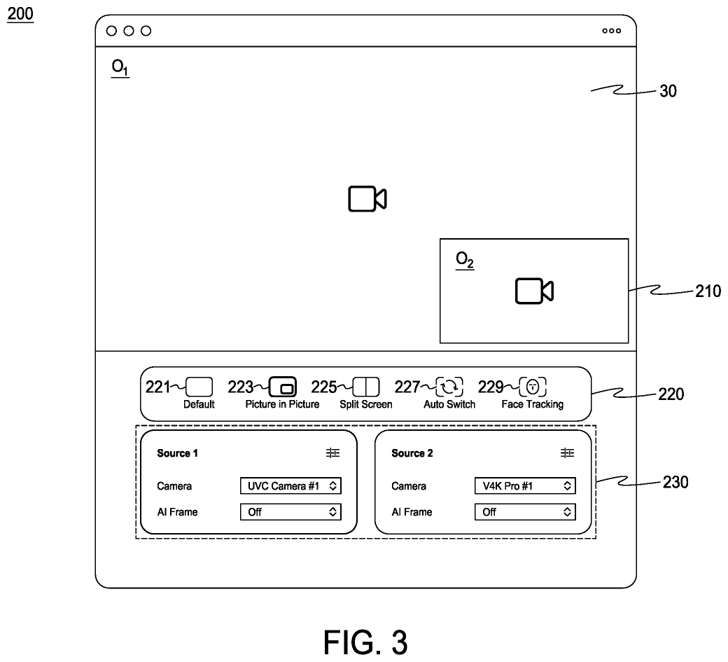

FIG. 3 is a diagram illustrating the UI displaying the virtual camera image that has multiple image sources according to an example implementation of the present disclosure.

Referring to FIG. 3, the PIP mode 223 may be selected (e.g., by the user).

In some implementations, in a case that only one image source exists and the PIP mode 223 is selected, the layout module 13 may take the output image associated with the one image source as the virtual camera image 30. As a result, the display area 210 may display a virtual camera image 30 that has only one image source.

In some implementations of the PIP mode 223, a plurality of the output images O1, O2 may be selected (e.g., by the user) for generating the virtual camera image 30 by the layout module 13. The layout module 13 may receive all of the one or more output images and generate the virtual camera image 30. For example, the layout module 13 may choose one of the selected output images as a main screen, scale down the other selected output image(s) as at least one sub-screen, and superimpose the at least one sub-screen on the main screen to generate the virtual camera image 30. As a result, the display area 210 may display a virtual camera image 30 that has multiple image sources. The selection of the plurality of output images may be similar to that described above for selecting one output image; thus, similar descriptions are not repeated herein.

In some implementations of the PIP mode 223, the total number of the image sources is two; therefore, no selection is needed. The layout module 13 may generate the virtual camera image 30 by setting one of the output images as the main screen, scaling down the other output image as the sub-screen, and superimposing the sub-screen on the main screen. As a result, the display area 210 may display a virtual camera image 30 that has two image sources.

For example, the first output image O1 from the first image processing module 11 and the second output image O2 from the second image processing module 12 are used by the layout module 13 for generating the virtual camera image 30, and the first output image O1 is chosen as the main screen (by default or by the user). The layout module 13 may scale down the second output image O2 and superimpose the scaled-down second output image O2 on the first output image O1 in order to generate the virtual camera image 30, as shown in the display area 210 of FIG. 3.

Split Screen Mode

The split screen mode 225 may also be known to as a picture-by-picture (PBP) mode.

In some implementations, in a case that only one image source exists, the split screen mode 225 may be disabled and prohibited from being selected.

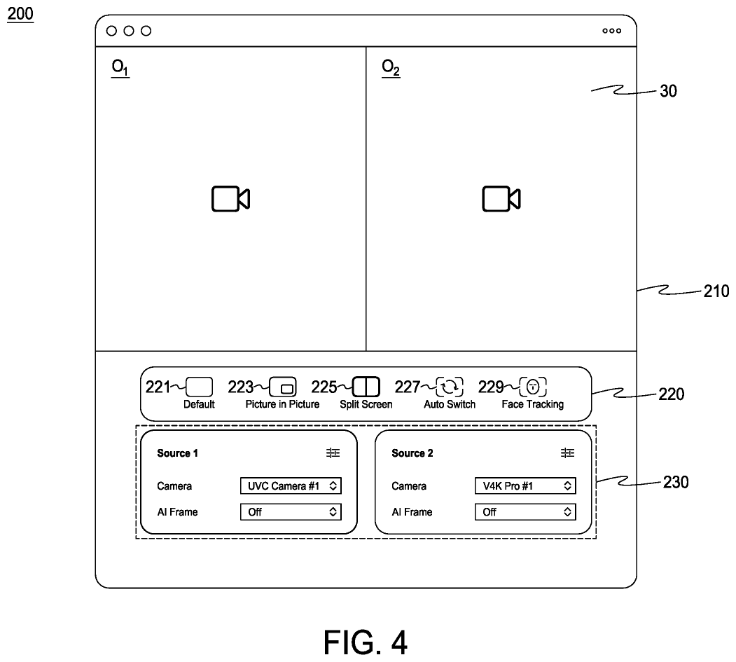

FIG. 4 is a diagram illustrating the UI displaying the virtual camera image that has multiple image sources according to another example implementation of the present disclosure.

Referring to FIG. 4, the split screen mode 225 may be selected (e.g., by the user).

In some implementations, in a case that only one image source exists and the split screen mode 225 is selected, the layout module 13 may take the output image associated with the only image source as the virtual camera image 30. As a result, the display area 210 may display a virtual camera image 30 that has only one image source.

In some implementations of the split screen mode 225, a plurality of the output images O1, O2 may be selected (e.g., by the user) for generating the virtual camera image 30 by the layout module 13. The layout module 13 may receive all of the one or more output images and generate the virtual camera image 30 by arranging the selected output images side by side. As a result, the display area 210 may display a virtual camera image 30 that has multiple image sources. The selection of the plurality of output images may be similar to that described above for selecting one output image; thus, similar descriptions are not repeated herein.

In some implementations of the split screen mode 225, the total number of the image sources is two; therefore, no selection is needed. The layout module 13 may generate the virtual camera image 30 by arranging the two output images side by side. As a result, the display area 210 may display a virtual camera image 30 that has two image sources.

For example, the first output image O1 from the first image processing module 11 and the second output image O2 from the second image processing module 12 are used by the layout module 13 for generating the virtual camera image 30. The layout module 13 may split the screen into a left half and a right half, put the first output image O1 in the left half, and put the second input image O2 in the right half in order to generate the virtual camera image 30, as shown in the display area 210 of FIG. 4.

Auto Switch Mode

In some implementations, the auto switch mode 227 may be selected.

In some implementations of the auto switch mode 227, only one of the one or more output images O1, O2 includes an indicator and the output image including the indicator may be selected for generating the virtual camera image 30 by the layout module 13. The layout module 13 may receive all of the one or more output images O1, O2 and take the selected output image as the virtual camera image 30. As a result, the display area 210 may display a virtual camera image 30 that has only one image source.

In some implementations of the auto switch mode 227, more than one of the output images O1, O2 includes the indicator, and all the output images including the indicator may be selected for generating the virtual camera image 30 by the layout module 13. For example, the layout module 13 may arrange the selected output images side by side to generate the virtual camera image 30. As a result, the display area 210 may display a virtual camera image 30 that has more than one image source. In some cases, the user may select one of the displayed output images/the image sources for display in display area 210.

In some implementations of the auto switch mode 227, more than one of the output images O1, O2 includes the indicator, and only one of the output images including the indicator may be selected for generating the virtual camera image 30 by the layout module 13. For example, a priority may be set for each image source and one of the output images including the indicator and associated with the highest priority may be selected and taken as the virtual camera image 30 by the layout module 13. For example, the layout module 13 may randomly select one of the output images including the indicator as the virtual camera image 30. As a result, the display area 210 may display a virtual camera image 30 that has only one image source.

In some implementations, the indicator may include at least one of a human, a finger, or a pen.

In some implementations, the indicator may include a human face.

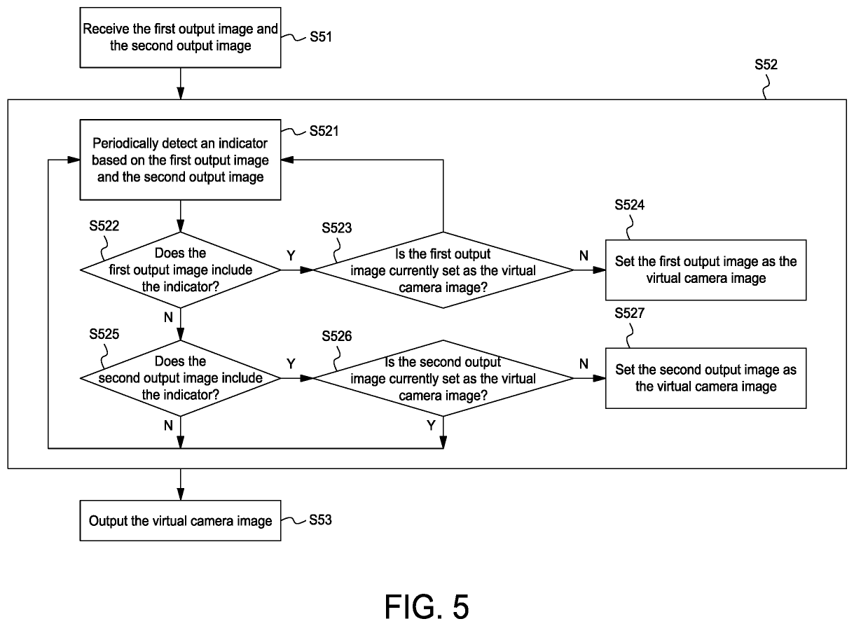

FIG. 5 is a flowchart illustrating a display method of an auto switch mode according to an example implementation of the present disclosure.

It is noted that the configuration of FIG. 1 will be used for describing implementations of FIG. 5, in which the auto switch mode 227 is selected and the first image source 21 has a higher priority than the second image source I2. However, the priority is not limited in the present disclosure.

Referring to FIG. 5, in action S51, the layout module 13 may (e.g., continuously) receive the first output image O1 and the second output image O2; in action S52, the layout module 13 may select one of the first output image O1 and the second output image O2 and set the selected output image as the virtual camera image 30.

In some implementations, the action S52 may include actions S521 to S527.

In action S521, the layout module 13 may periodically (e.g., once per second) detect the indicator (e.g., a human face) based on the first output image O1 and the second output image O2.

In action S522, in a case that the first output image O1 includes the indicator, the process may proceed to action S523; otherwise, the process may proceed to action S525.

In action S523, the layout module 13 may determine whether the first output image O1 is currently set as the virtual camera image 30. In a case that the first output image O1 is currently set as the virtual camera image 30, the process may go back to action S521; otherwise, the process may proceed to action S524.

In action S524, the layout module 13 may set the first output image O1 as the virtual camera image 30, and the process may continue to action S53.

In action S525, in a case that the second output image O2 includes the indicator, the process may proceed to action S526; otherwise, the process may go back to action S521.

In action S526, the layout module 13 may determine whether the second output image O2 is currently set as the virtual camera image 30. In a case that the second output image O2 is currently set as the virtual camera image 30, the process may go back to action S521; otherwise, the process may proceed to action S527.

In action S527, the layout module 13 may set the second output image O2 as the virtual camera image 30, and the process may continue to action S53.

In action S53, the layout module 13 may output the virtual camera image 30, then the process may go back to action S51. The outputted virtual camera image 30 may, for example, be displayed in the display area 210 or serve as an input of an application (e.g., an image processing application such as Photoshop® by Adobe® Inc., a video conferencing application such as Skype® by Microsoft® Corporation or Zoom™ by Zoom Video Communications, Inc., etc.).

Face Tracking Mode

In some implementations, the face tracking mode 229 may be selected. In the face tracking mode 229, a human face may be designated and the layout module 13 may always select the output image having the designated human face as the virtual camera image 30 and, as such, the designated human face is tracked.

In some implementations of the face tracking mode 229, the layout module 13 may generate a face setting image for designating a human face by the user and select the output image having the designated human face as the virtual camera image 30. In this case, the face setting image may include all of the human faces in the one or more output images O1, O2.

For example, the layout module 13 may detect human face(s) in each of the one or more output images O1, O2 and determine at least one of the one or more output images O1, O2 in which at least one human face is included. The layout module 13 may generate a face setting image by including the selected at least one output image each including at least one human face and display the face setting image using the display area 210. In this case, the user may designate one of the human face(s) from the face setting image. Once a human face is designated, the layout module 13 may extract a plurality of features of the designated human face for later identification.

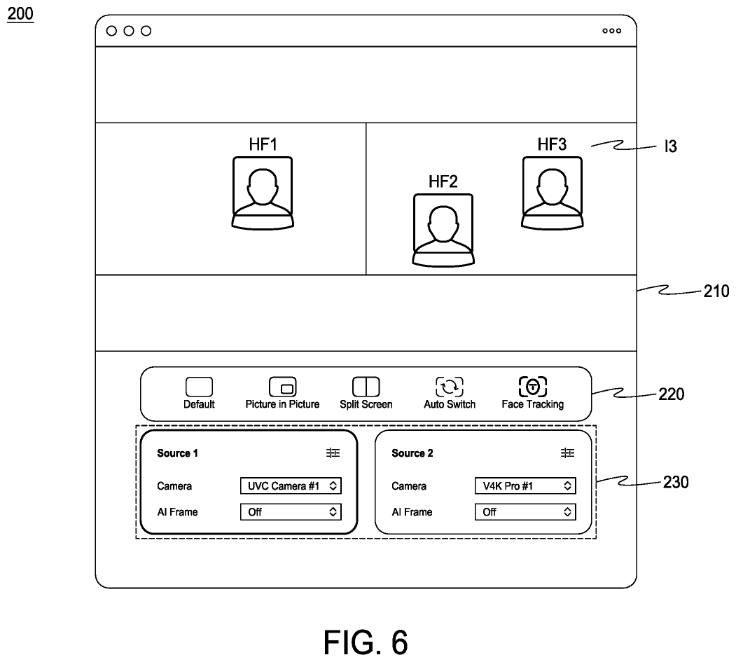

FIG. 6 is a diagram illustrating a face setting image according to an example implementation of the present disclosure.

Referring to FIG. 6, the output images O1, O2 includes human faces HF1, HF2, HF3. In a case that there are no other output images or no human face is included in other output images, the two output images O1, O2 may be selected for generating a face setting image 13. In some cases, the face setting image 13 may be generated by arranging the two output images O1, O2 side by side, and the generated face setting image 13 may be displayed in the display area 210, as shown in FIG. 6. As such, the user may designate one of the human faces HF1, HF2, HF3 by interacting with the user interface 200 (e.g., by clicking one of the human faces HF1, HF2, HF3).

In the following description, the output image(s) that includes the designated human face may be referred to as candidate image(s).

In some implementations of the face tracking mode 229, the layout module 13 may identify the designated human face based on the one or more output images for determining the candidate image(s). In a case that more than one candidate image is determined, only one of the candidate images may be selected for generating the virtual camera image 30 by the layout module 13. For example, a priority may be set for each image source and one of the candidate images associated with the highest priority may be selected and taken as the virtual camera image 30 by the layout module 13. For example, the layout module 13 may randomly select one of the candidate images as the virtual camera image 30. As a result, the display area 210 may display a virtual camera image 30 that has only one image source.

In some implementations of the face tracking mode 229, the layout module 13 may identify the designated human face based on the one or more output images for determining the candidate image(s). In a case that no output image including the designated human face is detected by the layout module 13 for a predetermined period (e.g., 10 seconds, 600 frames, etc.), the layout module 13 may automatically select one of the output image(s) as the virtual camera image 30. For example, the layout module 13 may retain the last-selected output image as being the virtual camera image 30 such that the image source of the virtual camera image 30 does not change. For example, a priority may be set for each image source and one of the output images associated with the highest priority may be selected and taken as the virtual camera image 30 by the layout module 13. For example, the layout module 13 may randomly select one of the output images as the virtual camera image 30.

In some implementations, the designated human face may be cropped and superimposed on a corner of the virtual camera image 30.

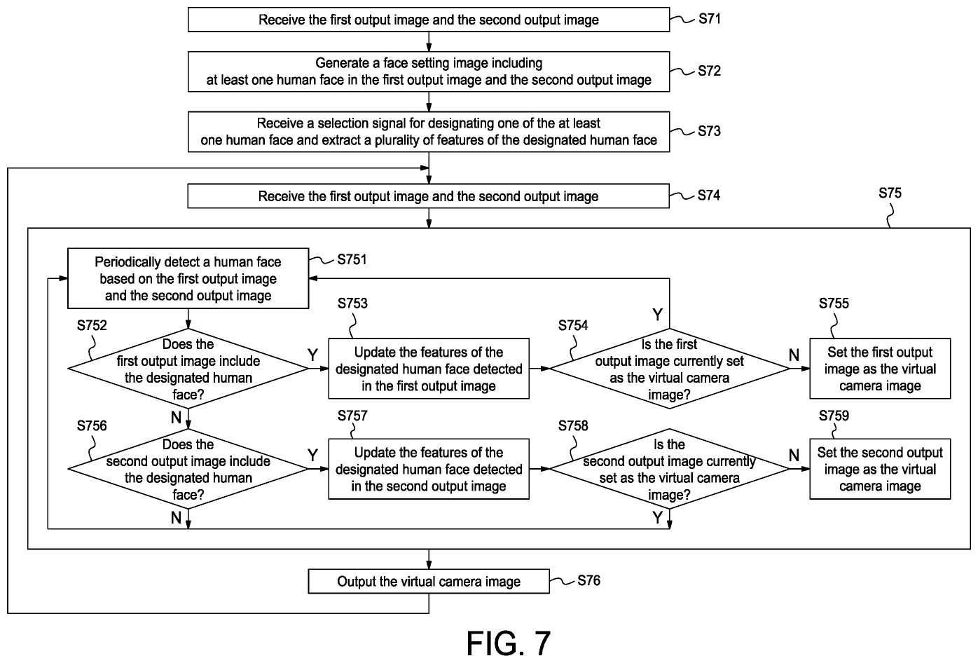

FIG. 7 is a flowchart illustrating a display method of a face tracking mode according to an example implementation of the present disclosure.

It is noted that the configuration of FIG. 1 will be used for describing implementations of FIG. 7, in which the face tracking mode 229 is selected and the first image source 21 has a higher priority than the second image source I2. However, the priority is not limited in the present disclosure.

Referring to FIG. 7, in action S71, the layout module 13 may receive the first output image O1 and the second output image O2.

In action S72, the layout module 13 may generate a face setting image I3 including at least one human face in the first output image O1 and the second output image O2. Details of the face setting image I3 have been described above and are not repeated herein.

In action S73, the layout module 13 may receive a selection signal for designating one of the at least one human face and extract a plurality of features of the designated human face. For example, the selection signal may be generated by the user as described above.

In action S74, the layout module 13 may (e.g., continuously) receive the first output image O1 and the second output image O2; in action S75, the layout module 13 may select one of the first output image O1 and the second output image O2 and set the selected output image as the virtual camera image 30.

In some implementations, action S75 may include actions S751 to S759.

In action S751, the layout module 13 may periodically (e.g., once per second) detect a human face based on the first output image O1 and the second output image O2 (e.g., according to the features of the designated human face), where the output image(s) including at least one human face may be referred to as candidate image(s).

In action S752, in a case that the first output image O1 includes the designated human face or the candidate image(s) includes the first output image O1, the process may proceed to action S753; otherwise, the process may proceed to action S756.

In action S753, the layout module 13 may update the features of the designated human face detected in the first output image O1, then the process may proceed to action S754.

In action S754, the layout module 13 may determine whether the first output image O1 is currently set as the virtual camera image 30. In a case that the first output image O1 is currently set as the virtual camera image 30, the process may go back to action S751; otherwise, proceed to action S755.

In action S755, the layout module 13 may set the first output image O1 as the virtual camera image 30, and the process may continue to action S76.

In action S756, in a case that the second output image O2 includes the designated human face or the candidate image(s) includes the second output image O2, the process may proceed to action S757; otherwise, the process may go back to action S751.

In action S757, the layout module 13 may update the features of the designated human face detected in the second output image O2, and the process may proceed to action S758.

In action 758, the layout module 13 may determine whether the second output image O2 is currently set as the virtual camera image 30. In a case that the second output image O2 is currently set as the virtual camera image 30, the process may go back to action S751; otherwise, the process may proceed to action S759.

In action S759, the layout module 13 may set the second output image O2 as the virtual camera image 30, and the process may continue to action S76.

In action S76, the layout module 13 may output the virtual camera image 30, then the process may go back to action S74. The outputted virtual camera image 30 may, for example, be displayed in the display area 210 or serve as an input of an application (e.g., an image processing application such as Photoshop® by Adobe® Inc., a video conferencing application such as Skype® by Microsoft® Corporation or Zoom™ by Zoom Video Communications, Inc., etc.).

AI Framing

In reference to FIG. 2, in some implementations, a function selection list may be provided in the image source configuration area 230 for selecting an image processing method to frame each input image I1, I2.

In a case that a first function is selected for the first image source 21 and a second function is selected for the second image source 22, the first image processing module 11 may perform a first image processing method of the first function on the first input image I1 and thus generate the first output image O1, and the second image processing module 12 may perform a second image processing method of the second function on the second input image I2 and thus generate the second output image O2.

In some implementations, the function selection list may include a portrait function, a conferencing function, and a document function.

In some implementations, in a case that no function is selected for a specific input image, the specific input image may not be framed for generating the corresponding output image.

In some implementations, the function selection list may not be limited in the use of more than one image source. The functions described as follows may also be implemented in the image processing device with only one image source.

Taking FIG. 2 as an example, in a case that only the first image source 21 exists, the image processing module 11 may also perform image processing on the first input image I1 and generate the first output image O1. In this case, the layout module 13 may not be needed, and the first output image O1 may be the same as the virtual camera image 30.

Portrait Function

In some implementations, the portrait function may be selected for an image source (e.g., the first image source 21 and/or the second image source 22), a corresponding image processing module (e.g., the first image processing module 11 and/or the second image processing module 12) may perform an image processing method of the portrait function on the input image (e.g., input image I1 and/or input image I2) from the image source and thus generate an output image (e.g., output image O1 and/or output image O2).

In some implementations of the portrait function, the image processing module may frame the input image based on indicator(s) in the input image and, more specifically, on location(s) and orientation(s) of the indicator(s) in the input image.

In some implementations of the portrait function, the indicator may be a human, a human face, a finger, and/or a pen, and the orientation of the indicator may be a torso orientation, a facing direction, and/or a pointing direction of a finger/pen.

In some implementations of the portrait function, in a case that only one indicator is detected in the input image and the orientation of the indicator is in a specific direction, the image processing module may frame the input image to focus on a region in the specific direction from the indicator, and thus generate an output image.

For example, in a case that a trunk of a human or a human face is facing to the right, a region to the right of the trunk of the human or the human face may be reserved in the output image.

For example, in a case that a pointing direction of a finger or a pen is pointing to the right, a region to the right of the fingertip or the pen tip may be reserved in the output image.

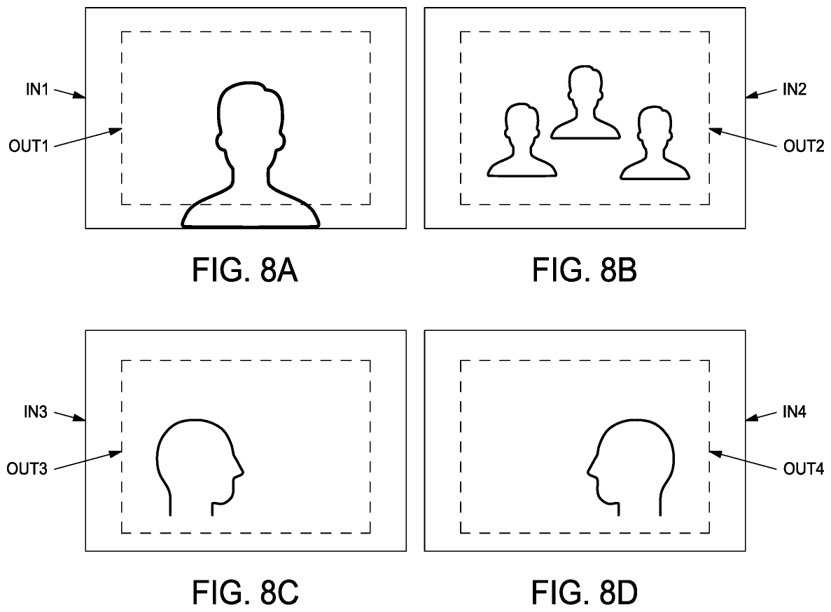

FIGS. 8A to 8D are diagrams illustrating output images of the portrait function according to an example implementation of the present disclosure.

Referring to FIGS. 8A to 8D, the portrait function may be selected, and the indicator may be a human face.

Referring to FIG. 8A, the image processing module may first detect the human face in an input image IN1. In a case that only one human face is detected in the input image IN1 and the human face is facing forward, the image processing module may frame the input image IN1 for focusing on the only human face in the input image IN1 and thus generate an output image OUT1. In some cases, the only human face may be arranged at a center region of the output image OUT1.

Referring to FIG. 8B, the image processing module may first detect the human face in an input image IN2. In a case that multiple human faces are detected in the input image IN2, the image processing module may frame the input image IN2 for focusing on all the human faces in the input image IN2 and thus generate an output image OUT2. In some cases, the human faces may be arranged at a center region of the output image OUT2.

Referring to FIG. 8C, the image processing module may first detect the human face in an input image IN3. In a case that only one human face is detected in the input image IN3 and the human face is facing to the right, the image processing module may frame the input image IN3 for focusing on a region at which the human face is staring and thus generate an output image OUT3. In some cases, the human face may be placed on the left side of the output image OUT3 to reserve space on the right side of the output image OUT3.

Referring to FIG. 8D, the image processing module may first detect the human face in an input image IN4. In a case that only one human face is detected in the input image IN4 and the human face is facing to the left, the image processing module may frame the input image IN4 for focusing on a region at which the human face is staring and thus generate an output image OUT4. In some cases, the human face may be placed on the right side of the output image OUT4 to reserve space on the left side of the output image OUT4.

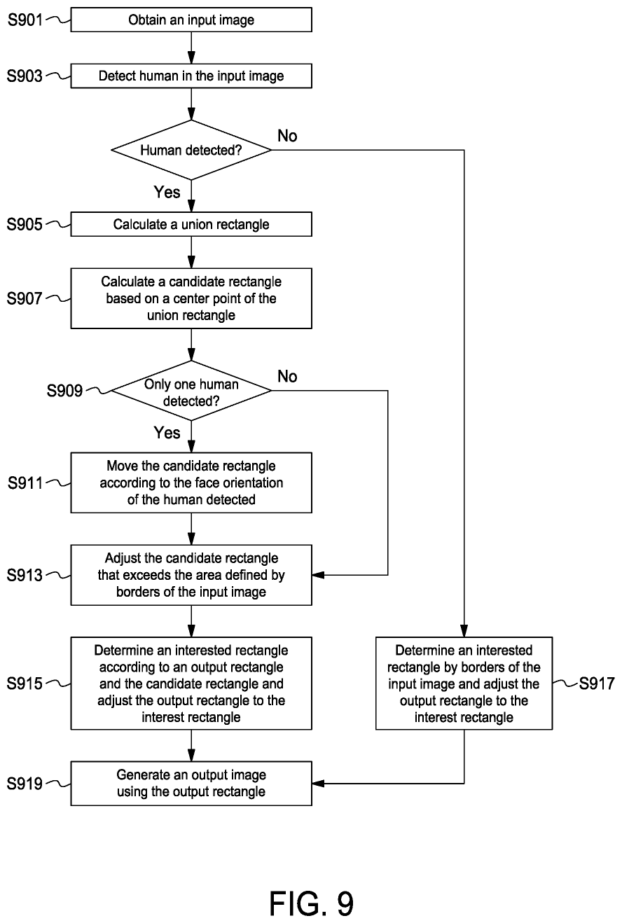

FIG. 9 is a flowchart illustrating an image processing method of the portrait function according to an example implementation of the present disclosure.

Referring to FIG. 9, the portrait function may be selected, and the indicator may be a human.

Referring to FIG. 9, in action S901, the image processing module may (e.g., continuously) receive an input image.

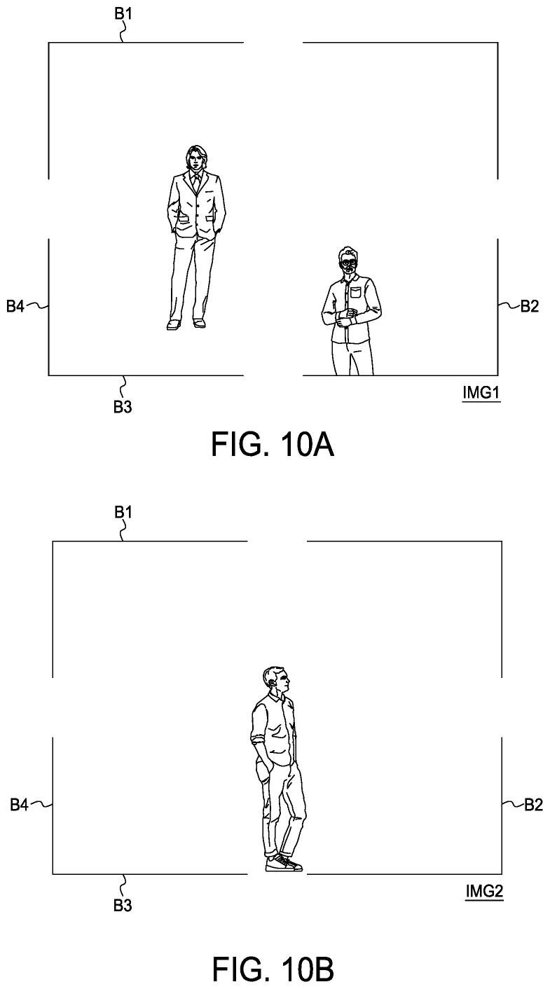

FIG. 10A is a diagram illustrating the input image according to an example implementation of the present disclosure; FIG. 10B is a diagram illustrating the input image according to another example implementation of the present disclosure.

Referring to FIG. 10A, in some implementations, an input image IMG1 including multiple humans may be received, and a field of view (FOV) of the corresponding image source may be, for example, defined by the borders B1, B2, B3, and B4 of the input image IMG1.

Referring to FIG. 10B, in some implementations, an input image IMG2 including only one human may be received, and the field of view (FOV) of the corresponding image source may be, for example, defined by the borders B1, B2, B3, and B4 of the input image IMG2.

Note that the aspect ratio of the input images IMG1 and IMG2 may depend on the FOV of the image source(s), which is not limited in the present disclosure.

Returning to FIG. 9, in action S903, the image processing module may detect a human in the input image. In a case that no human is detected in the input image, the process may proceed to action S917; otherwise, the process may proceed to action S905.

In some implementations, an object detection algorithm may be performed by the image processing module. The object detection algorithm may be a human detection algorithm using architectures such as You Only Look Once, Version 3 (YOLOv3), YOLOv4, ShuffleNet, etc., but is not limited thereto.

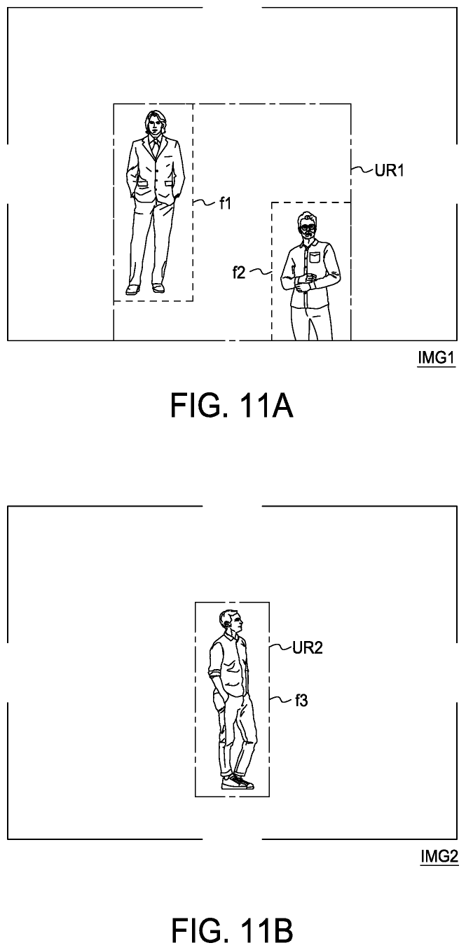

FIG. 11A is a diagram illustrating a union rectangle UR1 calculated based on the input image IMG1 shown in FIG. 10A according to an example implementation of the present disclosure; FIG. 11B is a diagram illustrating a union rectangle UR2 calculated based on the input image IMG2 shown in FIG. 10B according to an example implementation of the present disclosure.

Taking the input image IMG1 of FIG. 10A as an example, two people are detected in the input image IMG1 and framed in the detected human frames f1, f2 as sown in FIG. 11A.

Taking the input image IMG2 of FIG. 10B as an example, only one person is detected in the input image IMG2 and framed in the detected human frame f3 as shown in FIG. 11B.

Returning to FIG. 9, in action S905, the image processing module may calculate a union rectangle.

In some implementations, the image processing module may calculate the union rectangle by at least including all the detected human frames.

Referring to FIG. 11A. the union rectangle UR1 is calculated by using the upper left corner of the detected human frame f1 and the bottom right corner of the detected human frame f2. However, the present disclosure is not limited thereto.

Referring to FIG. 11B, in a case that only one human is detected in the input image the union rectangle UR2 may be the same as the detected human frame f3.

Returning to FIG. 9, in action S907, the image processing module may calculate a candidate rectangle based on a center point of the union rectangle.

In some implementations, size information (e.g., an aspect ratio) of the candidate rectangle may be determined in advance according to, for example, the size of the input image or an output image.

In some implementations, the image processing module may calculate a candidate rectangle with a predetermined aspect ratio such that the union rectangle is included in the candidate rectangle and the center point of the union rectangle overlaps with the center point of the candidate rectangle.

In some implementations, the image processing module may further move the candidate rectangle up a distance for reserve space above the head of the detected human. The distance may be, for example, 5% of a height of the candidate rectangle.

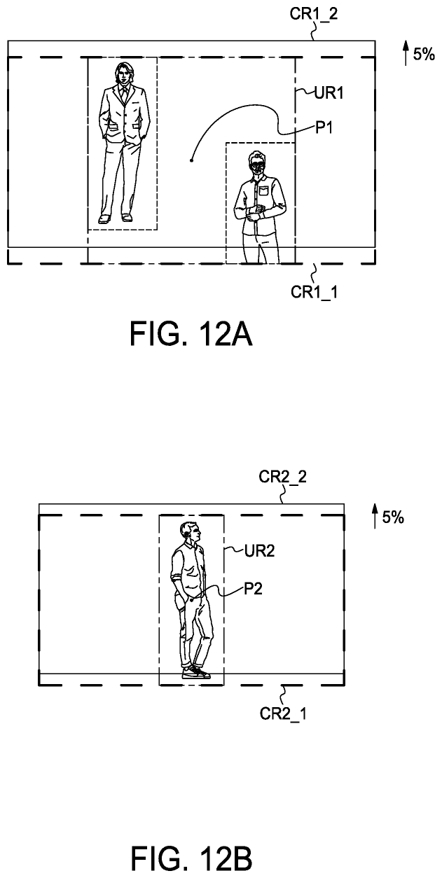

FIG. 12A is a diagram illustrating a candidate rectangle calculated based on the union rectangle UR1 shown in FIG. 11A according to an example implementation of the present disclosure; FIG. 12B is a diagram illustrating a candidate rectangle calculated based on the union rectangle UR2 shown in FIG. 11B according to an example implementation of the present disclosure.

Referring to FIG. 12A, the image processing module may calculate a candidate rectangle CR1_1 with the predetermined aspect ratio (e.g., 16:9) such that the union rectangle UR1 is included in the candidate rectangle CR1_1. The center point of the union rectangle UR1 overlaps with the center point of the candidate rectangle CR1_1 at point P1.

In some implementations, the image processing module may further move the candidate rectangle CR1_1 to the candidate rectangle CR1_2, so as to reserve a space above the human's head.

Referring to FIG. 12B, the image processing module may calculate a candidate rectangle CR2_1 with the predetermined aspect ratio (e.g., 16:9) such that the union rectangle UR2 is included in the candidate rectangle CR2_1. The center point of the union rectangle UR2 overlaps with the center point of the candidate rectangle CR2_1 at point P2.

In some implementations, the image processing module may further move the candidate rectangle CR2_1 to the candidate rectangle CR2_2, so as to reserve a space above the human's head.

Returning to FIG. 9, in action S909, the image processing module may determine whether there is only one human detected in the input image. In a case that only one human is detected in the input image, the process may proceed to action S911; otherwise, the process may proceed to action S913.

In action S911, the image processing module may move the candidate rectangle according to a face orientation or torse orientation of the human in the input image.

In some implementations, the image processing module may perform a face detection algorithm (e.g., using Receptive-Field Block Net, Vision by Apple Inc., etc.) to obtain the human's face in the input image then determine the face orientation (e.g., using an architecture such as HopeNet) based on the detected face, but which is not limited thereto. In a case that the face orientation indicates that the human faces toward a first direction, the image processing module may move the candidate rectangle along the first direction until a border of the candidate rectangle overlaps with a border of the union rectangle.

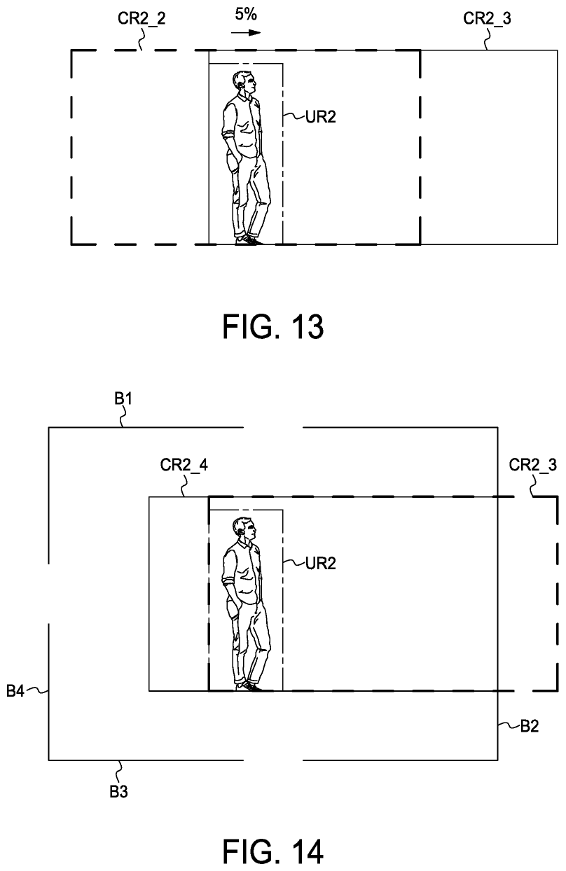

FIG. 13 is a diagram illustrating a movement of the candidate rectangle CR2_2 shown in FIG. 12B according to an example implementation of the present disclosure.

Referring to FIG. 13, the human's face is facing to the first direction D1 (e.g., right). Therefore, the image processing module may move the candidate rectangle CR2_2 along the first direction D1 (e.g., to the right) until the (left) border of the candidate rectangle CR2_3 overlaps with the (left) border of the union rectangle UR2.

Returning to FIG. 9, in action S913, the image processing module may adjust the candidate rectangle that exceeds the area defined by the borders of the input image.

In some implementations, the image processing module may adjust the position of the candidate rectangle such that the candidate rectangle does not exceed the borders of the input image. For example, in a case that the candidate rectangle exceeds the top border of the input image, the image processing module may move the candidate rectangle down such that the top border of the candidate rectangle overlaps with the top border of the input image; in a case that the candidate rectangle exceeds the right border of the input image, the image processing module may move the candidate rectangle to the left such that the right border of the candidate rectangle overlaps with the right border of the input image; in a case that the candidate rectangle exceeds the bottom border of the input image, the image processing module may move the candidate rectangle up such that the bottom border of the candidate rectangle overlaps with the bottom border of the input image; in a case that the candidate rectangle exceeds the left border of the input image, the image processing module may move the candidate rectangle to the right such that the left border of the candidate rectangle overlaps with the left border of the input image.

FIG. 14 is a diagram illustrating an adjustment of the candidate rectangle CR2_3 shown in FIG. 13 according to an example implementation of the present disclosure.

Referring to FIG. 14, the candidate rectangle CR2_3 exceeds, for example, the right border B2 of the input image IMG2. Therefore, the image processing module may move the candidate rectangle CR2_3 to the left to obtain the candidate rectangle CR2_4 such that the right border of the candidate rectangle CR2_4 overlaps with the right border B2 of the input image.

Returning to FIG. 9, in action S915, the image processing module may determine an interested rectangle according to an output rectangle and the candidate rectangle and adjust the output rectangle to the interested rectangle. Specifically, the output rectangle is a rectangle in the FOV of the image source for generating the output image.

In some implementations, the image processing module may determine the interested rectangle according to a distance between the center of the output rectangle and the center of the candidate rectangle. In a case that the distance is larger than a distance threshold (e.g., 10% of the width or 10% of the height of the output rectangle), the image processing module may set the interested rectangle as the candidate rectangle and gradually adjust the output rectangle to the interested rectangle in a predetermined time (e.g., 1.2 second) so as to avoid the content of the output image changing too quickly.

In some implementations, in a case that the distance is not larger than the distance threshold, the image processing module does not move the output rectangle and the FOV of the output image remains unchanged.

In some implementations, the image processing module may determine the interested rectangle according to an area difference between the output rectangle and the candidate rectangle. In a case that the area difference is larger than an area difference threshold (e.g., 20% of the output rectangle), the image processing module may set the interested rectangle as the candidate rectangle and gradually adjust the output rectangle to the interested rectangle in a predetermined time (e.g., 1.2 second), so as to avoid the content of the output image changing too quickly.

In a case that the distance is not larger than the distance threshold and the area difference is not larger than the area difference threshold, the image processing module does not move the output rectangle and the FOV of the output image remains unchanged.

In view of the above discussion, the adjustment within the predetermined time may include at least one of a position adjustment and a size adjustment, and may be accomplished by, for example, a predetermined frames per second (fps) and/or an interpolation method.

It is noted that the output rectangle is used for generating the output image. Advantageously, the output image can remain stable when the image source shakes slightly or when the image content is not substantially changed.

Returning to FIG. 9, in a case that no human is detected in the input image, in action S917, the image processing image may determine an interested rectangle by the borders of the input image and adjust the output rectangle to the interested rectangle.

In some implementations, the image processing module may define the interested rectangle by the borders B1, B2, B3, and B4 of the input image and gradually adjust the output rectangle to the interested rectangle in a predetermined time (e.g., 1.2 second). The adjustment within the predetermined time may include at least one of a position adjustment and a size adjustment, and may be accomplished by, for example, a predetermined fps and/or an interpolation method.

Turning to FIG. 9, in action S919, the image processing module may generate the output image using the output rectangle.

In some implementations, the image processing module may crop the output rectangle from the input image to generate the output image. The output image may be, for example, served as one of the input(s) of the layout module 13.

Conferencing Function

In some implementations, the conferencing function may be selected for an image source (e.g., the first image source 21 or the second image source 22), a corresponding image processing module (e.g., the first image processing module 11 or the second image processing module 12) may perform an image processing method of the conferencing function on the input image (e.g., input image I1 or input image I2) from the image source and thus generate an output image (e.g., output image O1 or output image O2).

In some implementations of the conferencing function, the image processing module may detect a human face in the input image, crop the detected human face(s) based on a number of human face(s) detected, and merge and arrange the cropped human face(s) to generate the output image.

In some implementations of the conference function, a maximum number (e.g., 8) of human face(s) to generate the output image may be predetermined. For example, in a case that a number of the human faces detected is greater than the predetermined maximum number, the image processing module may randomly select the maximum number of human faces for generating the output image. For example, in a case that a number of the human faces detected is greater than the predetermined maximum number, the human faces for generating the output image may be selected in a predetermined direction (e.g., from the left to right or from the right to left). For example, the image processing module may be configured to detect at most the maximum number of human faces.

In some implementations, each number of the human face(s) may correspond to a layout for merging and arranging the cropped human face(s) to generate the output image. However, the layout corresponding to each number is not limited in the present disclosure.

In some implementations, an aspect ratio of each human face cropped may be determined based on the layout for merging and arranging the cropped human face(s) to generate the output image.

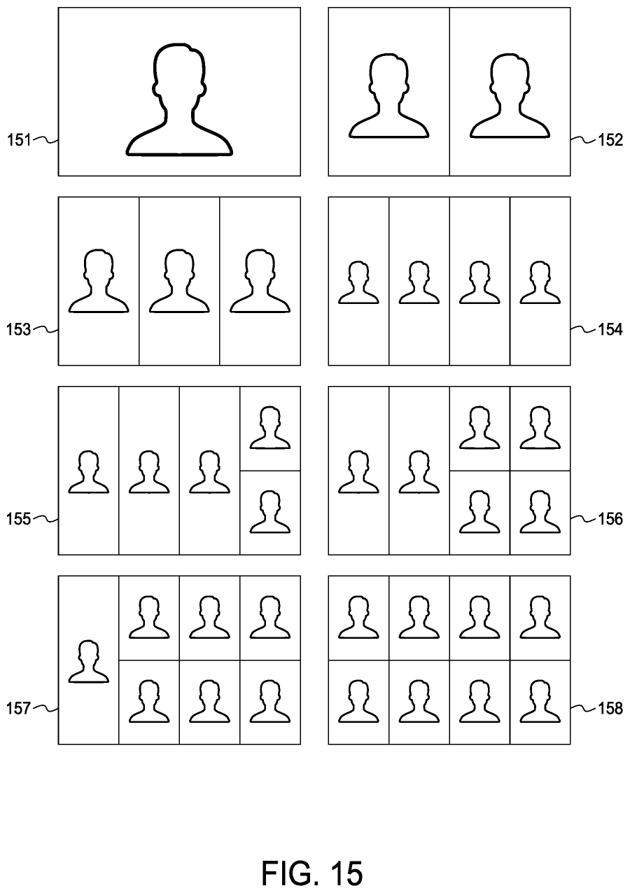

FIG. 15 is a diagram illustrating output images of the conference function according to an example implementation of the present disclosure.

Referring to FIG. 15, the output images 151 to 158 are exemplary output images for 1 to 8 human faces detected in the input image, respectively. The aspect ratio of each cropped human face may not be the same as each other.

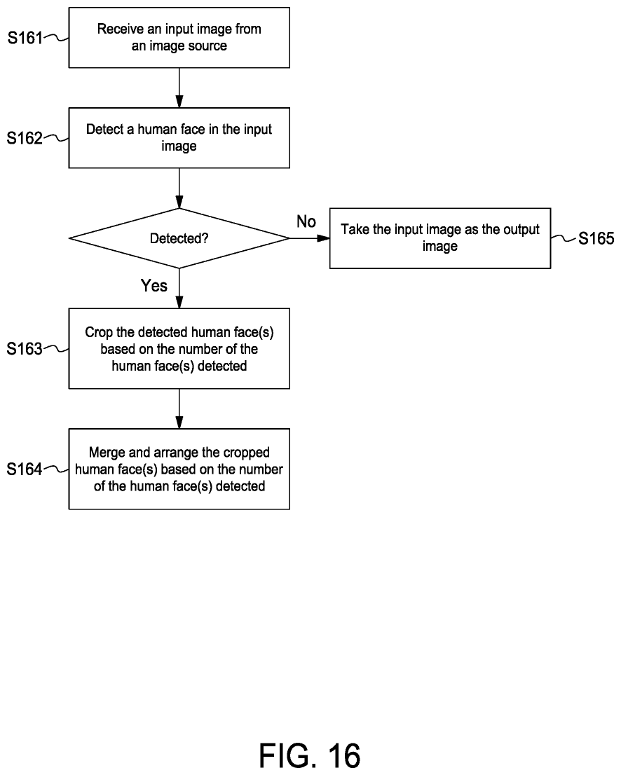

FIG. 16 is flowchart illustrating an image processing method of the conferencing function according to an example implementation of the present disclosure.

Referring to FIG. 16, in action S161, the image processing module may (e.g., continuously) receive an input image from a corresponding image source; in action S162, the image processing module may detect a human face in the input image. In a case that at least one human face is detected in the input image, the process may proceed to action S163; otherwise, the process may proceed to action S165 to take the input image as the output image.

In action S163, the image processing module may crop the detected human face(s) based on the number of the human face(s) detected in action S162, and the process may proceed to action S164.

In action S164, the image processing module may merge and arrange the cropped human face(s) based on the number of the human face(s) detected in action S162.

Document Function

In some implementations, the document function may be selected for an image source (e.g., the first image source 21 or the second image source 22), a corresponding image processing module (e.g., the first image processing module 11 or the second image processing module 12) may perform an image processing method of the document function on the input image (e.g., input image I1 or input image I2) from the image source and thus generate an output image (e.g., output image O1 or output image O2).

In some implementations of the document function, the input image may be framed for focusing on the content of a document in the input image. In some cases, at least a rotation (e.g., deskew), a keystone correction, or a scaling may be performed on the document in the input image for generating the output image. In some cases, a filling (e.g., color or pattern filling) may be also performed for generating the output image.

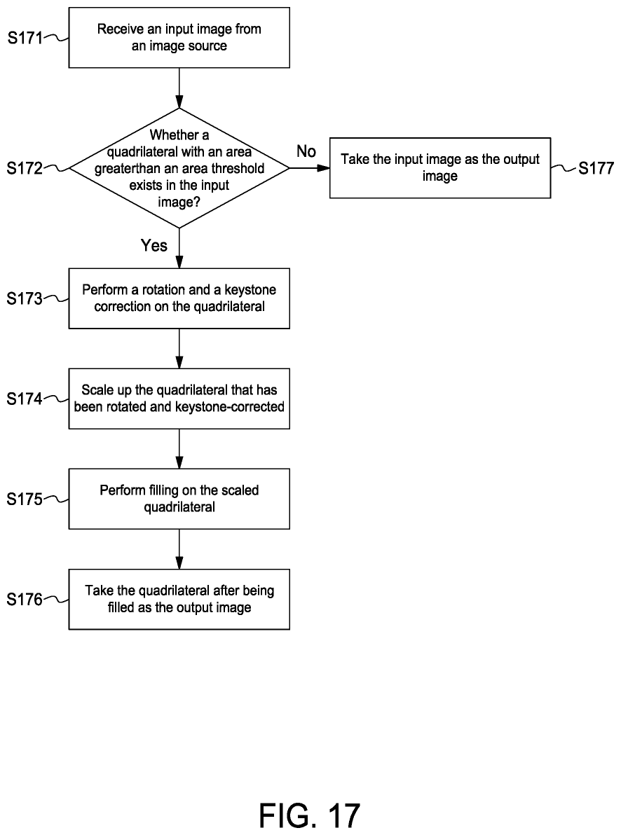

FIG. 17 is flowchart illustrating an image processing method of the document function according to an example implementation of the present disclosure.

Referring to FIG. 17, in action S171, the image processing module may (e.g., continuously) receive an input image from a corresponding image source; in action S172, the image processing module may detect whether a quadrilateral with an area greater than an area threshold exists in the input image. For example, the area threshold may be 20% of the area of the input image. However, the area threshold is not limited to such examples in the present disclosure.

In a case that no quadrilateral is detected in the input image, the process may proceed to action S177 to take the input image as the output image.

In a case that only one quadrilateral with an area greater than the area threshold is detected, the process may process to action S173.

In a case that a plurality of quadrilaterals with areas greater than the area threshold are detected, the image processing module may select one of the plurality of quadrilaterals. For example, the image processing module may randomly select one of the plurality of quadrilaterals. For example, the image processing module may select one of the plurality of quadrilaterals with a greatest area. However, the selection criteria are not limited to such examples in the present disclosure.

In action S173, the image processing module may perform a rotation (e.g., deskew) and a keystone correction on the selected quadrilateral. Details of the rotation and the keystone correction may be implemented by one of skill in the art based on their knowledge; therefore, such operations are not described in the present disclosure.

In action S174, the image processing module may scale up the quadrilateral that has been rotated and keystone-corrected, such that a height or a width thereof may be equal to a height or a width of the output image.

For example, the image processing module may scale up the quadrilateral proportionally. Once the height/width of the quadrilateral reaches the height/width of the output image, the scaling may be stopped.

As long as the aspect ratio of the quadrilateral is different from that of the output image, the quadrilateral after being scaled up may not fill the output image.

In action S175, the image processing module may perform filling (e.g., color or pattern filling) on the scaled quadrilateral such that the size of the filled quadrilateral equals the size of the output image.

In some implementations, the image processing module may perform color filling on the scaled quadrilateral by using a background color of the scaled quadrilateral. For example, in a case that the background of the detected quadrilateral is white, the color white may be used for color filling; in a case that the background of the detected quadrilateral is black, the color black may be used for color filling.

In some implementations, the image processing module may perform color filling on the scaled quadrilateral by using a contrasting color of the background color of the scaled quadrilateral.

In some implementations, the image processing module may perform color filling on the scaled quadrilateral by using a predetermined color (e.g., black or white) regardless of the background color of the scaled quadrilateral.

In action S176, the image processing module may take the quadrilateral after being filled in action S175 as the output image.

Some implementations described herein are described in the general context of a method or process, which in some implementations may be implemented by a computer program product embodied on a computer-readable medium, which may include computer-executable instructions (such as program code). The computer-executable instructions may be executed, for example, by computers in a networked environment. The computer-readable media may include removable and non-removable storage devices including, but not limited to, read-only memory (ROM), random-access memory (RAM), compact disks (CDs), digital versatile disks (DVDs), and the like. Accordingly, computer-readable media may include non-transitory storage media. Generally, program modules may include routines, programs, objects, components, data structures, etc. that perform particular tasks or implement particular data types. Computer- or processor-executable instructions, associated data structures, and program modules represent examples of program code for executing steps of methods disclosed herein. The particular sequence of such executable instructions or associated data structures represents examples of corresponding actions for implementing the functions described in such steps or processes.

Some of the disclosures may be implemented as devices or modules using hardware circuits, software, or a combination thereof. For example, a hardware circuit implementation may include discrete analog and/or digital components, which may, for example, be integrated as part of a printed circuit board. Alternatively or additionally, the disclosed components or modules may be implemented as Application-Specific Integrated Circuit (ASIC) and/or Field-Programmable Gate Array (FPGA) devices. Additionally or alternatively, some implementations may include a digital signal processor (DSP), which is a special-purpose microprocessor with an architecture optimized for the operational needs of digital signal processing associated with the disclosed functionality of the present disclosure. Similarly, components or subassemblies within each module may be implemented in software, hardware, and/or firmware. Connections between modules and/or components within modules may be provided using any connection method and medium known in the art, including but not limited to communications over the Internet, wired networks, or wireless networks using appropriate protocols.

From the present disclosure, it is manifested that various techniques may be used for implementing the concepts described in the present disclosure without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present disclosure is not limited to the particular implementations described above. Still, many rearrangements, modifications, and substitutions are possible without departing from the scope of the present disclosure.

What is claimed is:

1. A method for performing image processing, the method comprising:
obtaining a first input image;
detecting at least one human based on the first input image; and
in a case that only one human is detected based on the first input image:
determining a first output region within the first input image based on a face orientation of the only one human detected; and
generating a first output image based on the first output region within the first input image.

2. The method of claim 1, further comprising:
in a case that a plurality of humans is detected based on the first input image:
determining the first output region within the first input image based on a plurality of positions of the plurality of humans detected; and
generating the first output image based on the first output region within the first input image.

3. The method of claim 1, further comprising:
determining first size information of the first output image,
wherein the first output region is further determined according to the first size information.

4. The method of claim 3, wherein the face orientation indicates that the only one human detected is facing towards a direction, and determining the first output region within the first input image based on the face orientation of the only one human detected comprises:
determining a candidate region based on a position of the only one human detected according to the first size information;
moving the candidate region along the direction without exceeding a border of the first input image; and
determining the first output region based on the candidate region.

5. The method of claim 1, further comprising:
obtaining at least one second input image;
generating at least one second output image based on the at least one second input image;
selecting one of a plurality of display modes; and
generating a virtual camera image based on the first output image and the at least one second output image according to the selected one of the plurality of display modes.

6. The method of claim 5, wherein in a case that the selected one of the plurality of display modes is a face tracking mode, generating the virtual camera image based on the first output image and the at least one second output image according to the selected one of the plurality of display modes comprises:
generating a face setting image including a plurality of faces in the first output image and the at least one second output image;
receiving a selection signal designating one of the plurality of faces;
determining, from the first output image and the at least one second output image, at least one candidate image that includes the designated one of the plurality of faces; and
generating the virtual camera image based on the at least one candidate image.

7. The method of claim 6, wherein determining, from the first output image and the at least one second output image, the at least one candidate image that includes the designated one of the plurality of faces comprises:
periodically detecting the designated one of the plurality of faces in the first output image and the at least one second output image; and
determining the at least one candidate image from one or more of the first output image and the at least one second output image in which the designated one of the plurality of faces is detected.

8. An image processing device comprising:
one or more processors; and
one or more non-transitory computer-readable media, coupled to the one or more processors and storing instructions which, when executed by the one or more processors, cause the image processing device to:
obtain a first input image;
detect at least one human based on the first input image; and
in a case that only one human is detected based on the first input image:
determine a first output region within the first input image based on a face orientation of the only one human detected; and
generate a first output image based on the first output region within the first input image.

9. The image processing device of claim 8, wherein the instructions, when executed by the one or more processors, further cause the image processing device to:
in a case that a plurality of humans is detected based on the first input image:
determine the first output region within the first input image based on a plurality of positions of the plurality of humans detected; and
generate the first output image based on the first output region within the first input image.

10. The image processing device of claim 8, wherein the instructions, when executed by the one or more processors, further cause the image processing device to:
determine first size information of the first output image,
wherein the first output region is further determined according to the first size information.

11. The image processing device of claim 10, wherein the face orientation indicates that the only one human detected is facing towards a direction, and determining the first output region within the first input image based on the face orientation of the only one human detected comprises:
determining a candidate region based on a position of the only one human detected according to the first size information;
moving the candidate region along the direction without exceeding a border of the first input image; and
determining the first output region based on the candidate region.

12. The image processing device of claim 8, wherein the instructions, when executed by the one or more processors, further cause the image processing device to:
obtain at least one second input image;
generate at least one second output image based on the at least one second input image;
select one of a plurality of display modes; and
generate a virtual camera image based on the first output image and the at least one second output image according to the selected one of the plurality of display modes.

13. The image processing device of claim 12, wherein in a case that the selected one of the plurality of display modes is a face tracking mode, generating the virtual camera image based on the first output image and the at least one second output image according to the selected one of the plurality of display modes comprises:
generating a face setting image including a plurality of faces in the first output image and the at least one second output image;
receiving a selection signal designating one of the plurality of faces;
determining, from the first output image and the at least one second output image, at least one candidate image that includes the designated one of the plurality of faces; and
generating the virtual camera image based on the at least one candidate image.

14. The image processing device of claim 13, wherein determining, from the first output image and the at least one second output image, the at least one candidate image that includes the designated one of the plurality of faces comprises:
periodically detecting the designated one of the plurality of faces in the first output image and the at least one second output image; and
determining the at least one candidate image from one or more of the first output image and the at least one second output image in which the designated one of the plurality of faces is detected.

15. A non-transitory computer-readable medium storing instructions which, executed by one or more processors of an electronic device, cause the electronic device to:
obtain a first input image;
detect at least one human based on the first input image; and
in a case that only one human is detected based on the first input image:
determine a first output region within the first input image based on a face orientation of the only one human detected; and
generate a first output image based on the first output region within the first input image.

16. The non-transitory computer-readable medium of claim 15, wherein the instructions, when executed by the one or more processors of the electronic device, further cause the electronic device to:
in a case that a plurality of humans is detected based on the first input image:
determine the first output region within the first input image based on a plurality of positions of the plurality of humans detected; and
generate the first output image based on the first output region within the first input image.

17. The non-transitory computer-readable medium of claim 15, wherein the instructions, when executed by the one or more processors of the electronic device, further cause the electronic device to:
determine first size information of the first output image,
wherein the first output region is further determined according to the first size information.

18. The non-transitory computer-readable medium of claim 17, wherein the face orientation indicates that the only one human detected is facing towards a direction, and determining the first output region within the first input image based on the face orientation of the only one human detected comprises:
determining a candidate region based on a position of the only one human detected according to the first size information;
moving the candidate region along the direction without exceeding a border of the first input image; and
determining the first output region based on the candidate region.

19. The non-transitory computer-readable medium of claim 15, wherein the instructions, when executed by the one or more processors of the electronic device, further cause the electronic device to:
obtain at least one second input image;
generate at least one second output image based on the at least one second input image;
select one of a plurality of display modes; and
generate a virtual camera image based on the first output image and the at least one second output image according to the selected one of the plurality of display modes.

20. The non-transitory computer-readable medium of claim 19, wherein in a case that the selected one of the plurality of display modes is a face tracking mode, generating the virtual camera image based on the first output image and the at least one second output image according to the selected one of the plurality of display modes comprises:
generating a face setting image including a plurality of faces in the first output image and the at least one second output image;
receiving a selection signal designating one of the plurality of faces;
determining, from the first output image and the at least one second output image, at least one candidate image that includes the designated one of the plurality of faces; and
generating the virtual camera image based on the at least one candidate image.
